(19) United States
(12) Patent Application Publication
(10) Pub. No.: US 2016/0023755 A1
(43) Pub. Date: Jan. 28, 2016

(54) SYSTEM AND METHOD FOR CONTROL OF QUADROTOR AIR VEHICLES WITH TILTABLE ROTORS

(71) Applicant: King Fahd University of Petroleum and Minerals, Dhahran (SA)

(72) Inventors: Moustafa Elshafei Ahmed Elshafei, Dhahran (SA); Mahmoud Abdelmagid Elfeky, Dhahran (SA); Abdul-Wahid Abdul-Aziz Saif, Dhahran (SA); Sami El ferik, Dhahran (SA); Mohammad Fahad Al-Malki, Dhahran (SA)

(73) Assignee: King Fahd University of Petroleum and Minerals, Dhahran (SA)

(21) Appl. No.: 14/269,322

(22) Filed: May 5, 2014

(51) Int. Cl. B64C 27/52; G08G 5/02; B64C 27/08

(52) U.S. Cl. CPC B64C 27/52; B64C 27/08; G08G 5/025; B64C 2201/024; B64C 2201/146

(57) ABSTRACT

A system and method of controlling quadrotor air vehicles (QRAV) that may include an additional two degrees of freedom for each of the four propellers of the QRAV. Each of the four rotors may be allowed to rotate (tilt) around two local axes selected from the x-axis (roll), y-axis (pitch), and z-axis (yaw). Control of the quadrotor including the additional two degrees of freedom allows thrust of each rotor to be direct in any direction of a semi-sphere. As a result, total control inputs of the QRAV may be increased to twelve, enabling smooth control to achieve superior and precise maneuverability. Additionally, the system and method is fault tolerant and capable of handling failures of any of the rotors. Commands to the propellers may be fully decoupled and achieved independently thereby giving pilots better control to execute difficult maneuvers.

### BACKGROUND

1. Field of the Disclosure

The present disclosure relates to a system and a method for control of quadrotor air vehicles (QRAV). The quadrotor air vehicle, also known as a quadrotor, quadrotor helicopter, quadrocoptor, or quadcopter, is a multi-rotor air vehicle that is lifted and propelled by four rotors. Quadrotors are classified as a rotocraft, as opposed to a fixed-wing aircraft, since the quadrotors derive lift from the rotation of revolving airfoils.

2. Description of the Related Art

In conventional helicopters, the rotational speed of the main rotor is usually kept constant, while control of the helicopters' motion is achieved by altering the pitch of the blades. This position dependent pitch is referred to as ‘cyclic’ and the blade's pitch is based on the blade's position in the rotor disk. However, unlike conventional helicopters, quadrotors employ fixed-pitch blades.

The control of QRAV is achieved by varying the rotational speed of one or more rotors, thereby changing a torque load, thrust, and lift characteristics of the QRAV. By comparison, the drag on the blades of the main rotor in conventional helicopters cause the main body of the helicopter to rotate and a rear tail rotor is needed as a balancing moment to counter the drag-induced torque. However, the rear tail rotor of helicopters reduces flight efficiency and does not contribute to the lift force. The quadrotor configuration eliminates the need for a rear tail rotor by employing counter-rotation of rotor pairs.

QRAV also have additional advantages over conventional helicopters in that quadrotors do not require mechanical linkages to vary the rotor blade pitch angle as the rotor blade spins. This simplifies the design and maintenance of the QRAV. Additionally, the use of four rotors allows each individual rotor to have a smaller diameter, compare to an equivalent helicopter main rotor, thus allowing each of the four rotors to possess less kinetic energy during flight and allow for a faster response. Moreover, the smaller diameter rotors have shorter blades which are easier to construct.

More recently, QRAV have become popular in unmanned aerial vehicle (UAV) research. These vehicles in related art may use electronic control systems and electronic sensors to help stabilize the aircraft. QRAV may be size compactly for agile maneuverability and can be flown both indoors and outdoors. QRAV may be used as a UAV for surveillance and reconnaissance by military and law enforcement agencies, as well as for search and rescue missions in a wide array of environments and conditions, from urban to remote locations. QRAV UAVs can be suitable for these tasks due to their autonomous capabilities and cost savings over other conventional methods.

QRAV may also be employed in manned aerial vehicles and can be employed in a wide range of commercial and military applications. Such applications may include: heavy transportation, construction of bridges and buildings, assembly of large pieces in factories, and rescue operations after natural disasters where roads and bridges are no longer usable.

For military applications, QRAV may perform vertical takeoff and landing (VTOL) and can be used in manned operations for effective transport and for military deployment operations in hostile environments where VTOL is a requirement. Additionally, QRAV can have maneuverability that may be superior to helicopters, such as the APACHE helicopter.

In related art, quadrotor configurations have been proposed for VTOL. For example, U.S. Pat. No. 2,452,726 to Buchet proposed the use of tilted rotors. The quadrotor's ability to take off and land vertically provides an attractive advantage over conventional airplanes. However, these configurations have suffered from poor performance and/or have burdened pilots with a heavy work load due to poor stability augmentation and limited control authority.

More recently, in related art, a twin rotor design was proposed in U.S. Pat. No. 3,666,209 to Taylor. This design was eventually realized in Boeing's Bell V-22 Osprey aircraft which began operating in 1989. The V-22 included a twin tilted rotor design and was the first tiltrotor aircraft with both vertical takeoff and landing (VTOL) and short takeoff and landing (STOL) capabilities. The V-22 was designed to combine both the functionality of a conventional helicopter with the long-range and the high-speed performance of a fixed wing aircraft.

The Bell Boeing team disclosed a Quad TiltRotor design in 1999 as an improvement over the previous V-22 twin rotor design. The original design goal was to have a maximum takeoff weight of 45,000 kg with a payload of up to 11,000 kg in hover. However, the design goal was revised and downsized in 2000 to be more V-22 based and was to have a payload of only 8,200 to 9,100 kg in hover. The final design materialized as the V-44 and had quad rotor titled rotors. Each of the quad rotors point vertically during takeoff, and then they are rotated and aligned horizontally during normal flight.

In WO 01/19673 (EP 1212238) to Krysinski et. al., a design of aircraft with two tilting rotors is introduced. The aircraft can fly in airplane mode as well as in helicopter mode. In U.S. Pat. No. D465,196 to Dammar, a four-propeller helicopter with four centrally driven rotors is shown. EP 1901153 to Kemper presents modeling of the dynamic behavior of a quadrotor with respect to variable centers of gravity and discusses control aspects of a quadrotor helicopter. U.S. Publication 2010/0243794 to Jermyn discusses a flying apparatus consisting of four fixed rotors. The device is capable of vertical takeoff, hovering, and changing directions by varying the relative speeds of rotors. However, the quadrotor is not robust against disturbances, wind gusts, or failure of any engine. For these reasons conventional quadrotors have not been popular in military or civilian applications.

U.S. Publication 2012/0241553 to Wilke describes a multi-rotor helicopter with full swash plate control that can still be operated even in case of on rotor failures. This gives it an advantage over conventional single-rotor helicopter. Wilke also proposes using swash plates for each rotor similar to the one used in single-rotor helicopters. The swash plates are used to change the pitch angle of the blades, causing change in the magnitude and direction of the rotor thrust. The technique provides additional control capabilities for lateral and yaw movements. Furthermore, U.S. Pat. No. 7,871,033 to Karem also describes an aircraft with tilted rotors that can achieve yaw rotation by opposite tilting of its twin rotors.

U.S. Pat. No. 8,322,648 to Kroetsch discloses a design for hovering quad rotor aerial vehicle with removable rotor arms and protective shrouds. The protective shrouds can be removed to reduce the weight of the vehicle, thereby increasing flight time. The rotor arms can also be removed to make transport of the vehicle easier. The removal of the rotor arms also simplifies field repair or replacement of damaged parts.

WO2013/048339 to Chan describes a design of an unmanned quadrotor aerial vehicle, a method for assembling a UAV, and a kit of parts for assembling the UAV. The UAV toy comprises a wing structure comprising elongated equal first and second wings; a support structure comprising first and second sections to a middle position of the wing structure.

Markus Ryll, Heinrich H. Bulthoff, and Paolo Robuffo Giordano, “Modeling and Control of a Quadrotor UAV with Tilting Propellers”, 2012 IEEE International Conference on Robotics and Automation, Minnesota, USA, May 14-18, 2012, incorporated herein by reference, proposes using titled rotors in quadrotors UAV. The tilting of the rotors is similar to the concept used in Bell V-44 tiltcopter. The proposed titling by Ryll et. al. basically adds one degree of freedom to each rotor. Specifically, each of the four propellers can be tilted around one axis with respect to the quadrotor body and adds four additional control outputs. The rotation of the rotor is performed around yᵣ axis. However, this design has already been employed in VTOL aicrafts, in which the rotors can rotate into a vertical position during takeoff, landing, and hovering, or can rotate to a horizontal position for forward flight, as is the case with the Bell V-44. The additional one degree of freedom proposed by Ryll et. al., however, is suitable for UAV missions and makes the UAV fully actuated with six degrees of freedom (3 translational positions and 3 rotational orientations) plus an additional two free inputs.

While this addition is good for UAVs, where only position and orientation of the UAV need to be controlled to follow the mission trajectory, the addition may not be sufficient for manned aircrafts. In particular, the control objective for manned aircrafts is usually the precise control over translational velocities and accelerations, in addition to precise and robust control over aircraft rotations. Moreover, the quad rotor configuration of Ryll et. al. is not fault tolerant. The aircraft will lose control in the event of a failure of any of the rotors, and the aircraft would not be able to survive and continue on with its mission.

To overcome this problem, Alessandro Freddi, Alexander Lanzon, and Sauro Longhi, “A Feedback Linearization Approach to Fault Tolerance in Quadrotor Vehicles”, the 18th IFAC World Congress, Milano (Italy) August, 2011, incorporated herein by reference, discusses a control method, in case of failure of a single rotor in conventional quadrotor air vehicles, based on feedback linearization approach in order to make the vehicle enter a constant angular velocity spin around its vertical axis, while retaining zero angular velocities around the other axis. These conditions can be used to design a second control loop to enable a vehicle to perform both trajectory and roll/pitch control when rotor failure is present. However, with the continuous spin of the aircraft, there is no guarantee for safe landing of manned quadrotors.

QRAV structure and control in the related art lacks the flexibility to meet the maneuverability and precision requirements needed for control and air vehicle management of manned quadrotors. An object of the present disclosure is to provide an improved quadrotor system and method to provide superior control and precision. The present disclosure provides superior fault tolerance for safe flight of manned quadrotors. In fact, the improved quadrotor system and method disclosed herein are fault tolerant against failure of any rotor, can fully function with two rotors, can fully function if one or more tilting servos fail, provide safe flight even if all servos fail, and provide emergency landing with a single rotor.

### SUMMARY

According to one aspect of the present disclosure, the system and method for control of quadrotor air vehicles (QRAV) with tiltable rotors provides improved control and air vehicle management of manned quadrotors. The system and method may include control of two tilting angles for each of the rotors to allow for fast and effective change in thrust direction for each of the rotors. Additionally, the system and method offers other unique features that make QRAV safer for manned operation that will be made clear and detailed in the disclosure below.

According to one embodiment of the disclosure, an air vehicle may comprise four rotors. A first pair of rotors of the four rotors may rotate in a first direction while a second pair of the four rotors may rotate in a second direction, opposite of the first direction. The angular speed of each of the rotors may be controlled independently. Separately, the thrust of each rotor may be independently tilted in any direction within a hemisphere. Therefore, the air vehicle may include a total of twelve independent control parameters to enable full and precise control to allow for superior maneuverability that cannot be achieved in conventional aircrafts and helicopters.

In one embodiment, a control panel may be provided in order for a pilot or operator of a QRAV to access and manipulate a plurality of control parameters for each of the four rotors. The control panel may include inputs in the form of one or more joysticks, one or more touch screen displays, and/or one or more display screens. The inputs may control parameters of the air vehicle such as rotational movement of the air vehicle, pitch, pitch rate, roll, roll rate, yaw angular velocity, yaw angle, hover elevation, lateral motion acceleration and/or ascending speed. The touch screen displays and/or the display screens may show information including one or more of: elevation, forward velocity, orientation of the air vehicle (roll, pitch, yaw), odometer, trip meter, fuel level, battery status, global positioning system (GPS) information, and geographic information system (GIS) information. The touch screen displays and/or the display screens may show information including rotational speed of one or more of the four rotors, power consumption, and alarm status (temperature, overpower, overspeed, etc.).

In one embodiment, the control panel may be connected to a flight computer, IMU, and/or flight instruments. The control panel may receive control inputs from one or more joysticks, and/or one or more touch screen displays. The control panel may receive outputs from the flight computer and may send instructions from the control inputs to the flight computer. In one embodiment, a central processing core may be provided to communicate with sensors, communication links, IMU, touch screens, display screens, control panel, servos, and/or actuators.

In one embodiment, a tilting mechanism may be provided to one or more of the four rotors. The tilting mechanism may include two joints and each rotor attached to the tilting mechanism may be tilted in two directions about two separate axes. Rotation of the tilting mechanism may be performed using hydraulic servos and/or electric servo motors.

The above system and method for control of QRAV, which will be described in more detail herein below, provides major improvement to the quadrotor configuration by providing twelve control parameters to enable full actuation and control of the air vehicle in order to execute precise and critical maneuvers. Additionally, the above system and method for control of QRAV enables control objectives to be easily decoupled. The present disclosure provides superior fault tolerance for safe flight of manned quadrotors. In fact, the improved quadrotor system and method disclosed herein are fault tolerant against failure of any rotor, can fully function with two rotors, can fully function if one or more tilting servos fail, provide safe flight even if all servos fail, and provide emergency landing with a single rotor.

### DESCRIPTION OF THE DRAWINGS

The characteristics and advantages of exemplary embodiments are set out in more detail in the following description, made with reference to the accompanying drawings.

FIG. 1A depicts a top view of an exemplary embodiment of a quadrotor air vehicle.

FIG. 1B depicts a side view of an exemplary embodiment of the quadrotor air vehicle.

FIG. 1C depicts a vehicle body axis and a fixed reference axis of rotors of an exemplary embodiment of the quadrotor air vehicle.

FIG. 2A depicts a top view of an exemplary embodiment of a mechanism for 3D tilting of rotors of a quadrotor air vehicle.

FIG. 2B depicts a side view of an exemplary embodiment of a mechanism for 3D tilting of the rotors of the quadrotor air vehicle.

FIG. 3 depicts a block diagram of an exemplary input and output interface with a control panel.

FIG. 4 depicts a perspective view of an exemplary air vehicle control panel.

FIG. 5 depicts a view of an exemplary pilot touch screen.

FIG. 6 depicts a flow chart of an exemplary control program.

FIG. 7 depicts a block diagram of an exemplary computer command, control, and communications (C4) unit.

FIG. 8 depicts a flow chart of an exemplary configuration setup.

FIG. 9 depicts an exemplary response of flight quality filters.

The above embodiments and modifications will be described in detail below. It should be understood, however, that there is no intention to limit the present disclosure to the specific forms disclosed, but on the contrary, the intention is to cover all modifications, alternative constructions, and equivalents falling within the spirit and scope of the present disclosure as defined by the appended claims.

### DETAILED DESCRIPTION

Objects, advantages, and features of the exemplary quadrotor air vehicle described herein will be apparent to one skilled in the art from a consideration of this specification, including the attached drawings.

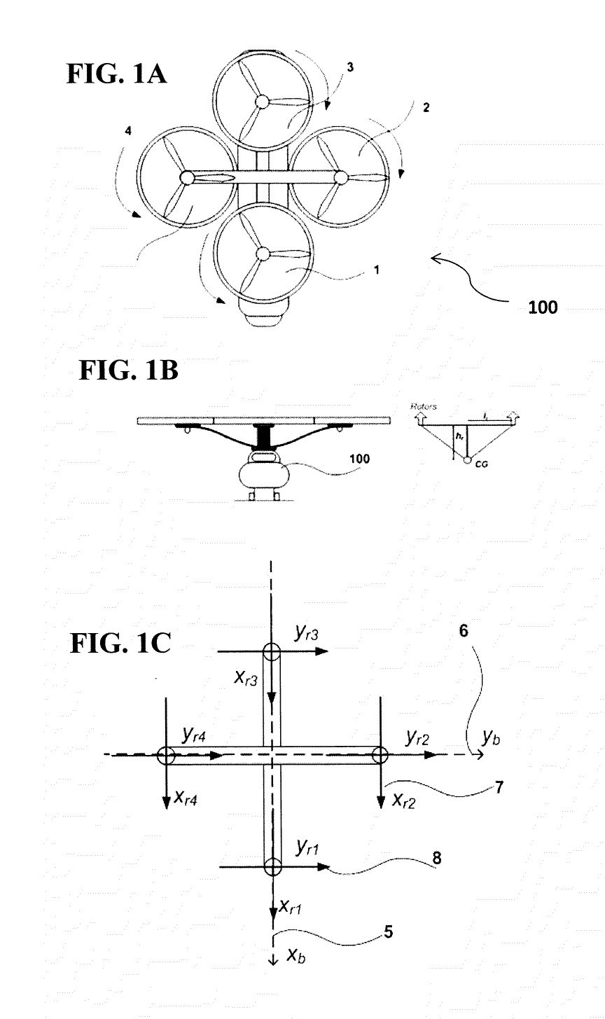

According to one embodiment as shown in FIGS. 1A and 1B, an air vehicle 100 may comprise four rotors 1, 2, 3, 4. Rotors 1, 4 may rotate in a first direction D₁, while rotors 2, 3 may rotate in a second direction D₂. For example, rotors 1, 4 may rotate in a counter-clockwise direction, while rotors 2, 3 may rotate in a clockwise direction. Alternatively, rotors 1, 4 may rotate in a clockwise direction, while rotors 2, 3 may rotate in a counter-clockwise direction.

In one embodiment, the angular speed of each of the rotors 1, 2, 3, 4 may be controlled independently. The rotors 1, 2, 3, 4 may be driven by brushless DC motors, or they may be driven by one or more fuel engines including speed control and rpm sensors. The thrust of each rotor 1, 2, 3, 4 may be independently tilted in any direction within a hemisphere. Therefore, each rotor 1, 2, 3, 4 includes three controllable parameters: the thrust Fᵢ and two tilt angles αᵢ and βᵢ. With four rotors 1, 2, 3, 4 present, the air vehicle 100 may include a total of twelve independent control parameters. These parameters may enable full and precise control of the air vehicle 100 to allow for superior maneuverability that cannot be achieved in conventional aircrafts and helicopters.

The disk loading P_{D} is defined as the ratio of helicopter weight to the total area swept by the rotors,

$${P}_{D} = \frac{{W}_{g}}{k π {R}^{2}} ,$$

where W_{g} is the gross weight of the air vehicle, k is the number of rotors, and R is the radius of the blades swept area. For example, the disk loading of a Boeing Bell Osprey MV22B aircraft (twin rotor VTOL) is about 129 kgw/m², and is about 72 kgw/m² for a Sikorsky CH-53 helicopter. For quad rotor aircrafts, the rotors may be powered by high-speed brushless motors and their disk loading may range from 45 to 125 kgw/m², providing a power of 2.5 to 7 KW/m².

The induced air velocity of a rotor may be described as,

$${v}_{i} = \sqrt{\frac{{T}_{i}}{A} \frac{1}{2 ρ}} ,$$

where T/A is the disk loading as before in N/m², and the power required for hover (in an ideal case) is described as,

$${P}_{i} = {T}_{i} {v}_{i} = {T}_{i} \sqrt{\frac{{T}_{i}}{A} \frac{1}{2 ρ}}$$

and the theoretical hover power/kg, Pₜ is

$${P}_{ti} = g \sqrt{\frac{{T}_{i}}{A} \frac{1}{2 ρ}} = g \sqrt{\frac{{P}_{Di}}{2 ρ}} .$$

For example, when disk loading is 50 kg, the power required is 140 watt/kg or 7 kw/m² of the rotor disk. It should be noted that the required power is inversely proportional to the radius of the rotor blade length.

Referring to FIG. 1C, directions of body reference axes of the vehicle are taken as follows, x_{b} 5 is along a longitudinal axis of the vehicle, y_{b} 6 is a left direction of the pilot, and z_{b} is pointing vertically. The rotors fixed reference axes are parallel to the body axis. Accordingly, reference axes xᵣᵢ are parallel to x_{b}, and reference axes yᵣᵢ are parallel to y_{b}. For example, the xᵣ₂ 7 reference axis is parallel to parallel to x_{b}, and the yᵣ₁ 8 reference axis is parallel to y_{b}.

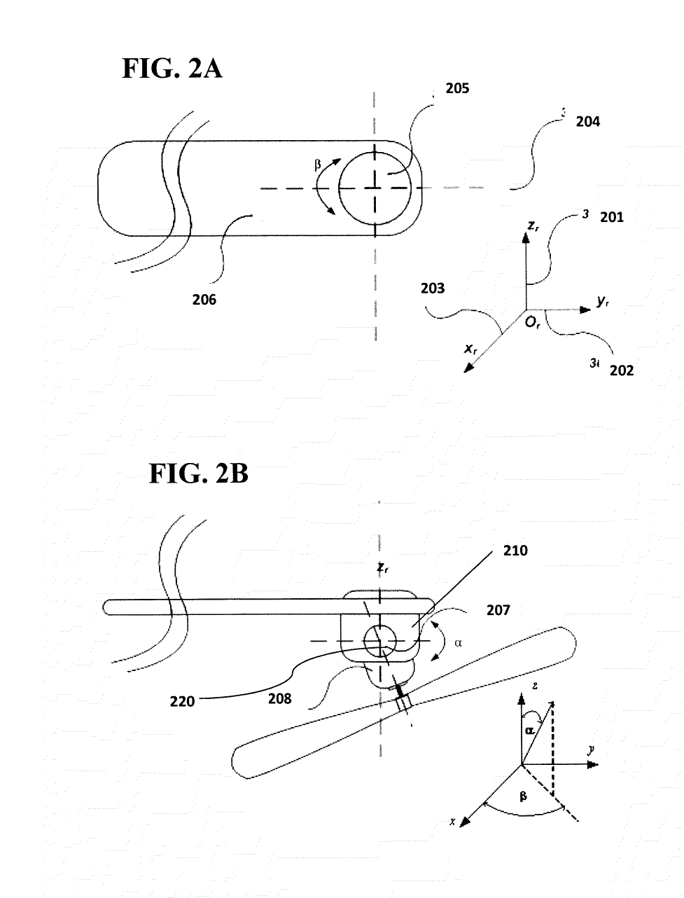

In one embodiment, one or more rotors of a QRAV may be provided with a tilting mechanism 200, as shown in FIGS. 2A and 2B. As shown in FIG. 2A, Or is an origin of fixed axis at the rotor base 210. Axis zᵣ 201, axis yᵣ 202, and axis xᵣ 203 are parallel to a body axis of the rotor fixed frame 220. Each rotor may be tilted in two directions about two separate axes by rotation around the zᵣ axis 201, and rotation about the xᵣ axis 203. The tilting mechanism consists of the two joints 205 and 207. The rotation of joint 205 may be limited to βₘₐₓ, while rotation of joint 207 may be limited to αₘₐₓ. In one embodiment, βₘₐₓ may be within +/−90 degrees. In one embodiment, αₘₐₓ may be between +/−20 degrees to +/−40 degrees. The rotation may be performed using standard hydraulic servos, or by electric servo motors. In one embodiment, standard hydraulic servos may be used in large vehicle applications, while electric servo motors may be used in small UAV applications.

The lifting thrust of a rotor is given by

T=cₜAᵣ(ρ/2)(ωR)²=bω²

where cₜ is the thrust coefficient (0.008-0.012), and Aᵣ is the area swept by blades. The cₜ depends on the shape of the blade and its pitch angle.

The blade moment

Mᵣ=c_{d}Aᵣ(ρ/2)(ωR)²R=dω²

where c_{d} is the drag coefficient (≈0.0006-0.0008), depending on the blade geometry and the pitch angle of the blade.

The orientation of the rotor may be controlled by two rotations about the rotor fixed frame 220, αᵢ, a rotation about the rotor xᵣ axis 203, and βi, about the rotor zᵣ axis 201, as shown in FIGS. 2A and 2B. The location of the center of gravity may not necessarily be on the same plane as the rotors, as shown in FIG. 2B. The rotor specific thrust may be a ratio of the thrust developed by the rotor to the drag power and is inversely proportional to ωR, the blade tip velocity.

In a conventional helicopter, high specific thrust can be obtained by using low rotor speed. The drag power increases by the tip velocity ωR and the tip speed of conventional helicopters is limited to approximately 0.7-0.8 Mach, or approximately 240-270 m/sec. As an example, if the rotor tip speed is limited to 240 m/sec, and the rotor radius is 2 meters, then the rotor angular speed should be about 1146 rpm. This would result in a disk load of about 35 kg/m².

To find the forces and torques generated by each tilted rotor on the air vehicle, let Rᵣᵢ^{oi} be the rotational matrix of the rotor with respect to fixed axis at Oi. Since the axis at Oi are parallel to the body axis at the center of gravity of the air vehicle, then

$${R}_{ri}^{oi} = {R}_{ri}^{B} = [ \begin{matrix}0 & 0 & c {β}_{i} s {α}_{i} \\ 0 & 0 & s {β}_{i} s {α}_{i} \\ 0 & 0 & c {α}_{i}\end{matrix} ] . \qquad ( EQ . 1 )$$

The thrust components of the ith rotor at the body center of gravity are then given by

$${F}_{i} [ \begin{matrix}0 & 0 & c {β}_{i} s {α}_{i} \\ 0 & 0 & s {β}_{i} s {α}_{i} \\ 0 & 0 & c {α}_{i}\end{matrix} ] [ \begin{matrix}0 \\ 0 \\ b {ω}_{i}^{2}\end{matrix} ] . \qquad ( EQ . 2 )$$

Similarly the moments of a titled rotor consist of two parts, the drag moment, and the moments generated by the thrust components. These two components can be expressed as

$${M}_{i} = [ \begin{matrix}0 & 0 & c {β}_{i} s {α}_{i} \\ 0 & 0 & s {β}_{i} s {α}_{i} \\ 0 & 0 & c {α}_{i}\end{matrix} ] [ \begin{matrix}0 \\ 0 \\ d {ω}_{i}^{2} δ ( i )\end{matrix} ] + {r}_{i} {xF}_{i} \qquad ( EQ . 3 )$$

where δ=[1,1,−1,−1], to account for the direction of rotation of each rotor, and where

$$axb = [ \begin{matrix}0 & - a 3 & a 2 \\ a 3 & 0 & - a 1 \\ - a 2 & a 1 & 0\end{matrix} ] [ \begin{matrix}b 1 \\ b 2 \\ b 3\end{matrix} ] .$$

rᵢ is the vector from CG to the reference points of the i^{th} rotor, i.e. r₁=[l,0,−h]′, r₂=[0,l,−h]′, r₃=[−l,0,−h]′, r₄=[0,−l,−h]′, as shown in FIG. 1B. From EQ. 2,
Fᵢₓ=CβᵢSαᵢbωᵢ²; for i=1, . . . 4
F_{iy}=SβᵢSαᵢbωᵢ²
Fᵢₓ=Cαᵢbωᵢ²
   Once the forces and moments at the center of gravity are found, the derivation of the dynamic equations can easily be derived using standard techniques, see for example

$$m [ \begin{matrix}\ddot{x} \\ \ddot{y} \\ \ddot{z}\end{matrix} ] = {R}_{EB} [ \begin{matrix}0 \\ 0 \\ - m g\end{matrix} ] - [ \begin{matrix}{K}_{1} \dot{x} \\ {K}_{2} \dot{y} \\ {K}_{3} \dot{z}\end{matrix} ] + {\sum }_{i = 1}^{4} {F}_{i} , \qquad ( EQ . 4 )$$

where R_{EB} is the inverse of the body Euler transformation matrix, and K₁, K₂, K₃ are air drag. Let

Ω=[\dot{φ},\dot{θ},\dot{ψ}]^{T},

the rotational dynamic equation can then be written as

I\dot{Ω}=−(Ω×IΩ)−M_{G}−M, (EQ. 5)

where I is the moment of inertia matrix of the air vehicle. In the shown embodiment, there are two axes of symmetry which result in a simple moment of inertia matrix.

M_{G} is the gyroscopic forces and is given by

$$\begin{matrix}{M}_{G} = {\sum }_{i = 1}^{4} {I}_{R} ( Ω x {\overline{ω}}_{i} ) δ ( i ) , & ( EQ . 6 ) \\ {\overline{ω}}_{i} = [ \begin{matrix}0 & 0 & c {β}_{i} s {α}_{i} \\ 0 & 0 & s {β}_{i} s {α}_{i} \\ 0 & 0 & c {α}_{i}\end{matrix} ] [ \begin{matrix}0 \\ 0 \\ {ω}_{i}\end{matrix} ] , and & ( EQ . 7 ) \\ M = {\sum }_{i = 1}^{4} {M}_{i} . & ( EQ . 8 )\end{matrix}$$

The body transformation matrix with respect to the earth inertia frame is given by

$${R}_{B}^{E} = {R}_{ψ} \cdot {R}_{θ} \cdot {R}_{φ} = [ \begin{matrix}c ψ & - s ψ & 0 \\ s ψ & c ψ & 0 \\ 0 & 0 & 1\end{matrix} ] [ \begin{matrix}c θ & 0 & s θ \\ 0 & 1 & 0 \\ - s θ & 0 & c θ\end{matrix} ] [ \begin{matrix}1 & 0 & 0 \\ 0 & c φ & - s φ \\ 0 & s φ & c φ\end{matrix} ] ,$$

where {ψ,θ,φ} are the body yaw, pitch, and roll respectively,

$${R}_{B}^{E} = [ \begin{matrix}c ψ c θ & - s ψ c φ + c ψ s θ s φ & s ψ s φ + c ψ s θ c φ \\ s ψ c θ & c ψ c φ + s ψ s θ s φ & - c ψ s φ + s ψ s θ c φ \\ - s θ & c θ s φ & c θ c φ\end{matrix} ] .$$

Equations EQ. 4 and EQ. 5 can be easily placed in the form of

\dot{X}=f(X,U)

where

X=[x,\dot{x},y,\dot{y},z,ż,φ,\dot{φ},θ,\dot{θ},ψ,\dot{ψ}]′=[x₁,x₂,x₃,x₄,x₅,x₆x₇,x₈,x₉,x₁₀,x₁₁,x₁₂]′,

U=[ω₁,α₁,β₁,ω₂,α₂,β₂,ω₃,α₃,β₃,ω₄,α₄,β₄],

Y=[\dot{x}_{B},\ddot{x}_{B},\dot{y}_{B},ÿ_{B},z,ż,φ,\dot{φ},θ,\dot{θ},ψ,\dot{ψ}]′,

where Y is the measurement from the instrumentation system as discussed in U.S. Pat. No. 8,260,477 to Al-Malki and Elshafei, and is hereby incorporated by reference.

During normal control of the air vehicle, the control panel may provide the operator with one or more of the following controls: forward speed/acceleration \dot{x},\ddot{x}; lateral speed/acceleration \dot{y}, ÿ; elevation/ascending speed z, ż; pitch control θ; yaw control \dot{ψ}; and/or roll control φ.

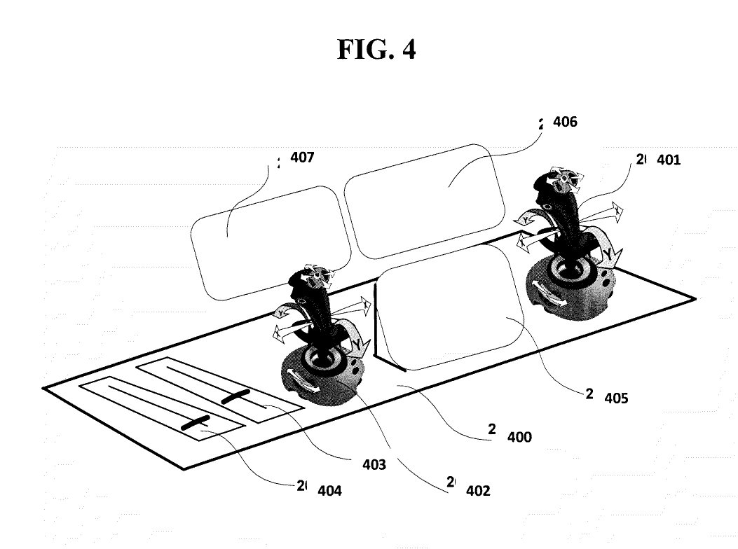

In one embodiment as shown in FIG. 4, a pilot control panel 400 may be used by a pilot or operator to take advantage of the twelve possible control inputs. The pilot control panel 400 may include two 3-axis joysticks 401 and 402, collective levers 403 and 404, a touch screen 405, and one or two display screens 406, 407.

In one embodiment, the right joystick 401 may be used by the pilot or operator to control the forward speed by moving the joystick forward and backward, and lateral speed may be controlled by moving the right joystick 401 horizontally left and right, while the forward acceleration, or thrust, may be controlled by twisting the right joystick 401. The right joystick 401 may also be equipped with additional buttons to allow the pilot to choose from acceleration control or velocity control, and to activate forward cruise control. Alternatively, the pilot may activate acceleration control from the touch screen 405. In a forward speed control, a forward speed may be proportional to the joystick lever position. A neutral position of the joystick may cause the aircraft to come to a hover state. However, in high maneuverability situations, such as in the combat scenario, the pilot may switch the forward speed control to a forward acceleration control. In the forward acceleration control, a forward acceleration may be proportional to the position of the joystick. The neutral position of the joystick may cause the aircraft to maintain its last forward speed. A soft switch on the touch screen 405 may enable the pilot to limit the actions of the joystick to the forward speed control only, reverse motion only, or both.

In one embodiment, the left joystick 402 may be used to control the rotational movements of the air vehicle. The forward/backward position may be used to control the pitch of the air vehicle, the left/right positions may be used to control the roll of the air vehicle, while twisting the left joystick 402 may control the yaw angular velocity. The control and functions of the right joystick 401 may be swapped with the left joystick 402, and vice versa. Alternatively, the right joystick 401, and the left joystick 402 may be customized to remap the different functions, described above, to different positions of the joysticks 401, 402, as desired by the pilot or operator.

In one embodiment, the position of the left lever 403 may be used to control the hover elevation of the air vehicle. The second lever 404 may be used to control the ascending speed z , or thrust of the air vehicle.

In one embodiment, the touch screen 405 may display additional controls to set the desired roll rate, pitch rate, lateral motion acceleration, and various light control. The status screens 406 may display the elevation in meters, the forward velocity, the orientation of the air vehicle (roll, pitch, yaw), the total odometer reading, the trip kilometers, fuel/battery status, and/or GPS/GIS location information. The status screens 406 may also display the rpm of the four rotors, power consumption, and possible alarm status as motor temperature, overpower, or over speed, etc.

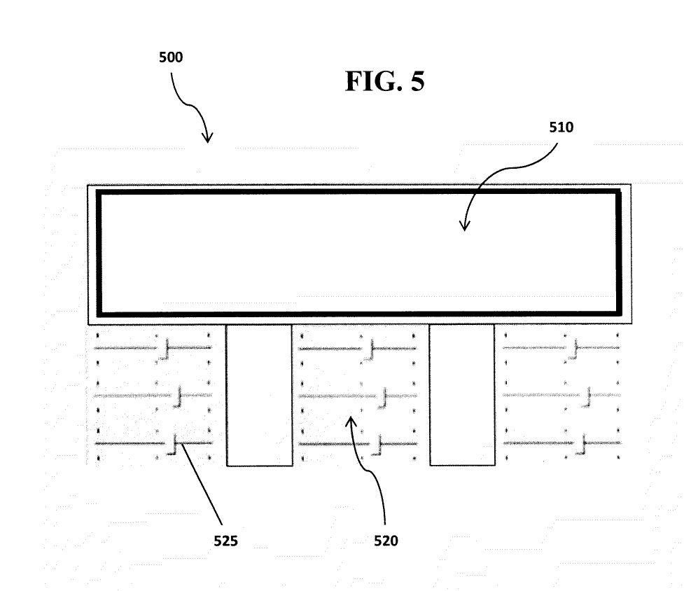

In one embodiment as shown in FIG. 5, a touch screen 500 may include at least a first display portion 510 for displaying status information. The touch screen may include a second display portion 520 for displaying one or more buttons and/or dials for adjusting control inputs of the QRAV. In one embodiment, slider dials 525 may be used to adjust the control inputs based on a fixed range of the control inputs. For example, a desired roll rate, pitch rate, or lateral motion acceleration may be altered by sliding a respective slider dial 525 on the touch screen.

In one embodiment, one of the first display portion 510 and the second display portion 520 may be configured to display elevation, forward speed, lateral speed, a bottom camera view, GIS location information, distance from origin, distance to destination, an altitude indicator, a time clock, and/or flight time. The other of the first display portion 510 and the second display portion 520 may be configured to display an odometer, fuel/battery status, GPS location, outside temperature, RPMs for each of the four rotors, tilt and pitch angles for each of the four rotors, roll and pitch angles, rate of fuel consumption, and/or total power %.

In one embodiment, other information may be displayed on one of the first display portion 510 and the second display portion 520. This information may include total flight time of the air vehicle, number of trips, and maintenance related information or schedules. In one embodiment, the touch screen 500 may include warning/alarm displays. The warning/alarm displays may output faults relating to any of the four motors, faults relating to any of the tilting servos, fuel or battery warnings, and inertial measurement unit (IMU) errors. In one embodiment, the touch screen 500 may include other nominal aircraft controls for a main power on/off, a front light, a beacon light, a cabinet light, door control/status, windows, a rescue elevator control panel, and/or communication instruments.

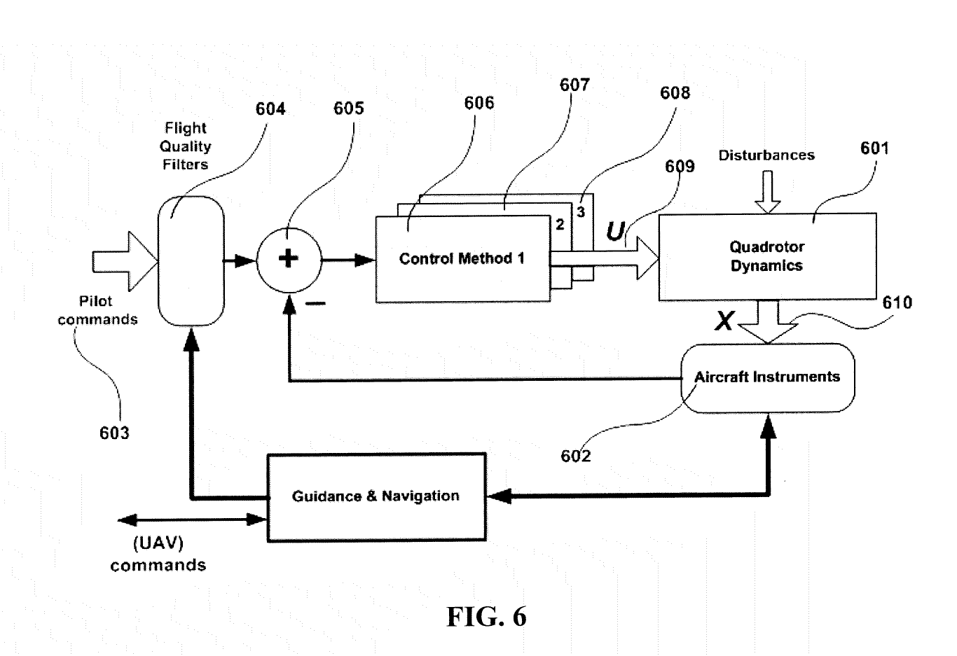

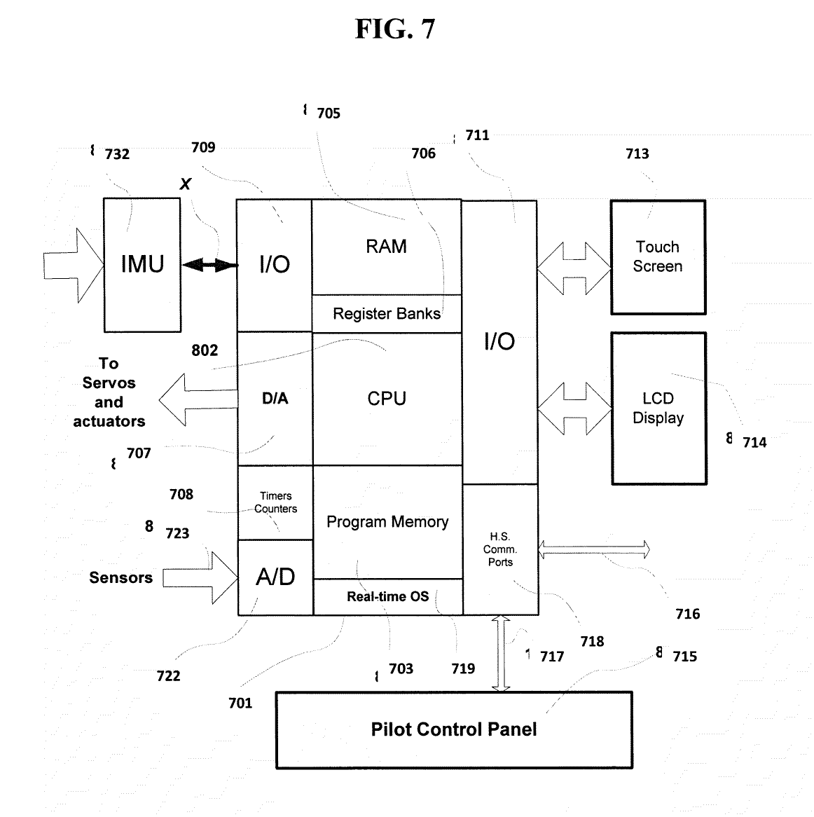

In one exemplary mode of operation, the pilot control panel 400 may, in response to the pilot's action, generate a command signal proportional to the pilot's action. For example, the position of joysticks 401, 402 may generate a signal sₘᵢₙ≦s≦sₘₐₓ. The value of the signal limits may be fixed and standardized in avionic instrumentation. For the purpose of the subsequent discussion, the signal s is taken to be normalized to take values between 0 and 1. The normalized command signals from the control panel will be referenced using the hat symbol above the letter, e.g., ŝ. Each command signal corresponds to some desired air vehicle motion state, such as velocity, acceleration, rotational angle, or rotational angular velocity. The mapping between the electrical signal and the desired vehicle state may be performed by a filter in the flight quality filter bank 604 in FIG. 6. To illustrate this concept in one non-limiting embodiment, let the right joystick 401 command signal be ŝ=\dot{ŷ}_{d}, corresponding to a desired lateral speed of \dot{y}_{d} in engineering units (e.g., meters/sec). The desired lateral speed can then be expressed (by way of example) as

$$\frac{{\dot{y}}_{d}}{{\hat{\dot{y}}}_{d}} = H ( s ) = \frac{K}{τ s + 1} .$$

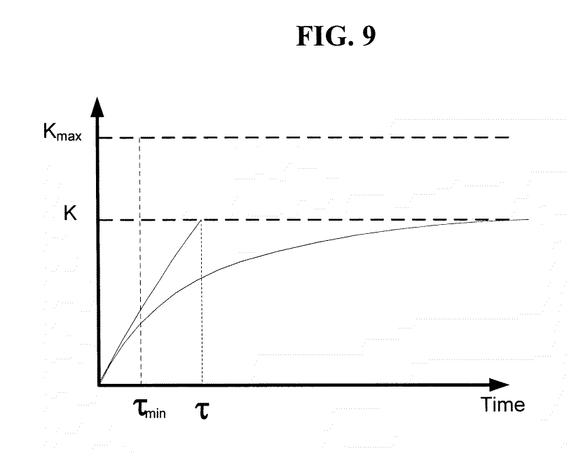

H(s) is a flight quality filter and the response of this example filter is shown in FIG. 9.

Referring to FIG. 9, Kₘₐₓ and τₘᵢₙ are the operating limits of the aircraft or the safe limits for a human pilot. Kₘₐₓ in this case represents the maximum lateral speed, while τ determines the rate of change of speed. The operating parameters K and τ may be set by the operator using the touch screen 500 in FIG. 5. For example, in combat operations, these parameters may be set to their limits K=Kₘₐₓ and τ=τₘᵢₙ, while in a pick-and-place mission, K may be selected to limit the lateral speed range to a few meters/sec, and τ to 5-10 seconds.

A separate filter may be provided for each operator command, and each of these filters may be characterized by four parameters, with (Kₘₐₓ, τₘᵢₙ) being constants for each aircraft, and operating parameters (K, τ) being set by the pilot using the touch screen 500, or may be preset for a particular mission.

The output from the flight control filters may include set-points for the vehicle control systems which determine the thrust of each motor and the tilting angles of each rotor. In one embodiment, the touch screen 500 may display and/or control one or more of the following: mission selection dialog; current mission mode; elevation control/ascending speed control; ascending control (K, τ); elevation (K, τ); yaw control (K, τ); pitch control (K, τ); roll control (K, τ); autopilot dialog (on/off, destination selection, arrival time); forward speed (K, τ); and forward acceleration in thrust mode (K, τ).

In one embodiment, the touch screen 500 may enable the pilot to limit a range of vehicle speed that can be reached by a full span of the joystick. In one exemplary pick-and-place mission to precisely install bridge construction parts, the range of speed control by the joystick may be limited to 1 or 2 meters/sec for precise motion and control of the air vehicle. Similarly, the pilot may set limits on the vehicle forward acceleration for specific missions. The setup may be saved and retrieved again in the future when the pilot starts similar missions.

In one embodiment, the touch screen 500 may enable the pilot to set up limits on lateral speeds and lateral accelerations for particular missions. Similarly, the pilot may set ranges for the controls performed by control panel 400 and accelerations for elevation, pitch control, yaw control, and roll control. As mentioned, the pilot may save a setup corresponding to a particular mission and retrieve the setup file when the pilot starts a similar mission.

In one embodiment, the aircraft may be provided with recommended manufacture configuration files for common flight missions. These common flight missions may include: training, transportation, combat, severe weather, rescue, pick-and-place, autopilot, limted24 (where the aircraft is limited to using rotors 2 & 4 only), limted13 (where the aircraft is limited to using rotors 1 & 3 only), limited quad (if one or more tilting servos fail), emergency landing, user defined 1 (based on a first user defined configuration), and user defined 2 (based on a second user defined configuration).

In one embodiment, the severe weather configuration may be used and the objective of this configuration would be to maintain stability of aircraft and avoid a loss of elevation. However, maintaining a desired forward speed or a desired mission path in this configuration may be compromised.

In one embodiment, the pick-and-place configuration may set precise positioning, trim velocities, and orientation as the main objectives, while limiting travel distance and speed. On the other hand, during combat, the combat configuration may be used to set high maneuverability and acceleration controls as the main control objectives.

In one embodiment, the autopilot configuration may be selected. The user may then input desired destination coordinates (possibly with the aid of GIS or a map), desired elevation, and target arrival time using the touch screen 500. The auto pilot configuration may be configured to maintain desired travel conditions while displaying a remaining distance to the destination and the remaining time. The pilot may turn off the autopilot configuration at any time by touching a button on the touch screen 500.

In one embodiment, an emergency landing may be performed if three rotors fail and the QRAV is left with only three control parameters: the motor thrust and two tilt angles. An emergency landing mode may be activated even if only one rotor is functioning. It is assumed that the one rotor has sufficient thrust to keep the aircraft at least in a hover state. In this emergency mode, the right joystick 401 may provide direct control over the two tilt angles of the functioning rotor. A thrust lever may be used to control the power of the functioning rotor.

The purpose of the emergency mode is to provide safe landing, which may be accomplished in two steps. In the first step, the objective is to maintain a safe elevation and to direct the aircraft to a safe location for landing. The aircraft may be spinning and/or tilted. The pilot may use his/her judgment to select between a tolerable spinning and steerability of the aircraft. In the second step, once a safe spot for landing is reached, the objective is to stop spinning and minimize tilting of the aircraft to enable safe landing.

The following exemplary chart illustrates the superior capability of a QRAV that may operate with twelve control inputs. For example, forward motion may be executed without introducing any rotational movements of the QRAV. Yaw movement with various angular speeds may be executed without any coupling with the roll or pitch. Similarly, the air vehicle may pitch in hover to aim at a ground target, or move laterally while maintaining a pitch or roll angle.

Activated Control Parameter

| | Action | α1 | α2 | α3 | α4 | β1 | β2 | β3 | β4 | F1 | F2 | F3 | F4 |
|---|---|---|---|---|---|---|---|---|---|---|---|---|---|
| 1 | Vertical motion | 0 | 0 | 0 | 0 | 0 | 0 | 0 | 0 | ✓ | ✓ | ✓ | ✓ |
| 2 | *Forward +x direction | +a | 0 | +a | 0 | 90° | 90° | 90° | 90° | — | — | — | — |
| 3 | *Backword −x direction | −a | 0 | −a | 0 | 90° | 90° | 90° | 90° | — | — | — | — |
| 4 | *Side motion +y | 0 | +a | 0 | +a | 0° | 0° | 0° | 0° | — | — | — | — |
| 5 | *Side motion −y | 0 | −a | 0 | −a | 0° | 0° | 0° | 0° | — | — | — | — |
| 6 | Yaw rotation CW | 0 | +a | 0 | −a | 0° | 0° | 0° | 0° | — | — | — | — |
| 7 | Yaw rotation CCW | 0 | −a | 0 | +a | 0° | 0° | 0° | 0° | — | — | — | — |
| 8 | Pitch + | 0° | 0° | 0° | 0° | 0° | 0° | 0° | 0° | ↑ | — | ↓ | — |
| 9 | Pitch − | 0° | 0° | 0° | 0° | 0° | 0° | 0° | 0° | ↓ | — | ↑ | — |
| 10 | Roll + | 0° | 0° | 0° | 0° | 0° | 0° | 0° | 0° | — | ↑ | — | ↓ |
| 11 | Roll − | 0° | 0° | 0° | 0° | 0° | 0° | 0° | 0° | — | ↓ | — | ↑ |

*Can be achieved using rotors 1 & 3 and/or rotors 2 & 4.

A control procedure and method of mapping the desired pilot commands to appropriate control actions will now be discussed. In one embodiment as shown in FIG. 6, the dynamics of the quadrotor 601 is measured by the on-board flight instruments 602, the measurement vector X 610 is then compared with the desired values in 605. The error, that is the difference between the desired and measured states of the air vehicle, is then used by the one of the control methods to produce the control vector U 609. The control method 606 may be the default method. Method 607 may be used in case of failure of rotor 2, or rotor 4, or both. Method 608 is used in case of failure of rotor 1, or rotor 3, or both.

In one embodiment, other control methods may also be switched on based on the mission or the pilot choice. For example the pilot may change from speed control to thrust mode if the pilot or operator wants to accelerate without deciding a desired final speed or level. The pilot may also set cruise control (autopilot) to maintain the flight states at a desired condition. The pilot commands from the control panel may first be filtered by a set of flight quality filters to ensure the rate of changes are within the human and equipment endurance and safety limits, and interlock conflicting commands.

Next, exemplary embodiments of control methods will be discussed:
a) A control method for elevation where an elevation lever 403, as shown in FIG. 4, is set to Z_{d}:

$${e}_{z} ( t ) = {z}_{d} - z ( t )$$

$${F}_{1} = {F}_{2} = {F}_{3} = {F}_{4} = {K}_{p 1} {e}_{z} ( t ) + {K}_{I 1} {\int }_{0}^{t} {e}_{z} ( t ) d t + {K}_{d} \frac{d {e}_{z} ( t )}{d t}$$

The pilot may switch control to the speed (thrust mode), where the pilot would have direct control over an ascending/descending speed of the air vehicle. The switching between elevation control and ascending speed control may be performed by the touch screen 500 or by a switch on the elevation lever 403.
b) A control method for forward velocity where the right joystick 401 is set to \dot{x}_{d}

$${e}_{x} ( t ) = {\dot{x}}_{d} - \dot{x}$$

$${β}_{1} = {β}_{3} = 90 °$$

$${α}_{1} = {α}_{3} = {K}_{p 2} {e}_{x} ( t ) + {K}_{I 2} {\int }_{0}^{t} {e}_{x} ( t ) d t + {K}_{d 2} \frac{d {e}_{x} ( t )}{d t}$$

In case of a failure of the titling servos or rotors 1 and/or 3, the tilt angles α2 and α4 would replace α1 and α3, respectively.
c) A control method for lateral velocity where the right joystick 401 is set to \dot{y}_{d}

$${e}_{y} ( t ) = {\dot{y}}_{d} - \dot{y}$$

$${α}_{2} = {α}_{4} = {K}_{p 3} {e}_{y} ( t ) + {K}_{I 3} {\int }_{0}^{t} {e}_{y} ( t ) d t + {K}_{d 3} \frac{d {e}_{y} ( t )}{d t} .$$

In case of a failure of the titling servos or rotors 2 and/or 4, the tilt angles α1 and α3 would replace α2 and α4, respectively. If a rotor for forward and lateral speed control is used, the combined tilt angles would be

$$sin ( α ) = \sqrt{{u}_{1}^{2} + {u}_{2}^{2}}$$

$$sin ( β ) = \frac{{u}_{2}}{\sqrt{{u}_{1}^{2} + {u}_{2}^{2}}}$$

where u₁ and u₂ are the controller outputs corresponding to the forward velocity and lateral velocity, respectively.
d) A control method for yaw rotation where the left joystick 402 is twisted to set the desired yaw rotation rate

$${e}_{ψ} ( t ) = {\dot{ψ}}_{d} - \dot{ψ} ( t )$$

$$Δ {α}_{2} = - Δ {α}_{4} = {K}_{p 4} {e}_{ψ} ( t ) + {K}_{I 4} {\int }_{0}^{t} {e}_{ψ} ( t ) d t$$

In case of a failure of the tilting servos or rotors 2 and/or 4, the tilt angles α1 and α3 replace α2 and α4, respectively.
e) A control method for pitch where the left joystick 402 is pushed forward/backward to set a desired pitch angle

$${e}_{θ} ( t ) = {θ}_{d} - θ ( t )$$

$$Δ {F}_{1} = - Δ {F}_{3} = {K}_{p 5} {e}_{0} ( t ) + {K}_{I 5} {\int }_{0}^{t} {e}_{θ} ( t ) d t$$

f) A control method for roll where the left joystick 402 is pushed right/left to set a desired roll angle

$${e}_{φ} ( t ) = {φ}_{d} - φ ( t )$$

$$Δ {F}_{2} = - Δ {F}_{4} = {K}_{p 6} {e}_{φ} ( t ) + {K}_{I 6} {\int }_{0}^{t} {e}_{φ} ( t ) d t$$

The above algorithms are exemplary embodiments for illustration only. Other efficient and robust versions of the algorithms known in the art may be applied based on the exemplary embodiments by those skilled in the art. Additionally, other powerful, but computationally demanding versions, of the algorithms may be designed and applied by those skilled in the art based on the exemplary embodiments discussed in the present disclosure.

In one embodiment, a central processing core 701 may be provided to interact with one or more touch screens 713, one or more display screens 714, the pilot control panel 715, one or more sensors 723, and IMU 732. The central processing core may send commands to servos and/or actuators of the QRAV having twelve total control inputs.

In one embodiment, a central processing core 701 may be provided to interact with one or more touch screens 713, one or more display screens 714, the pilot control panel 715, one or more sensors 723, and IMU 732. The central processing core may send commands to servos and/or actuators of the QRAV having twelve total control inputs.

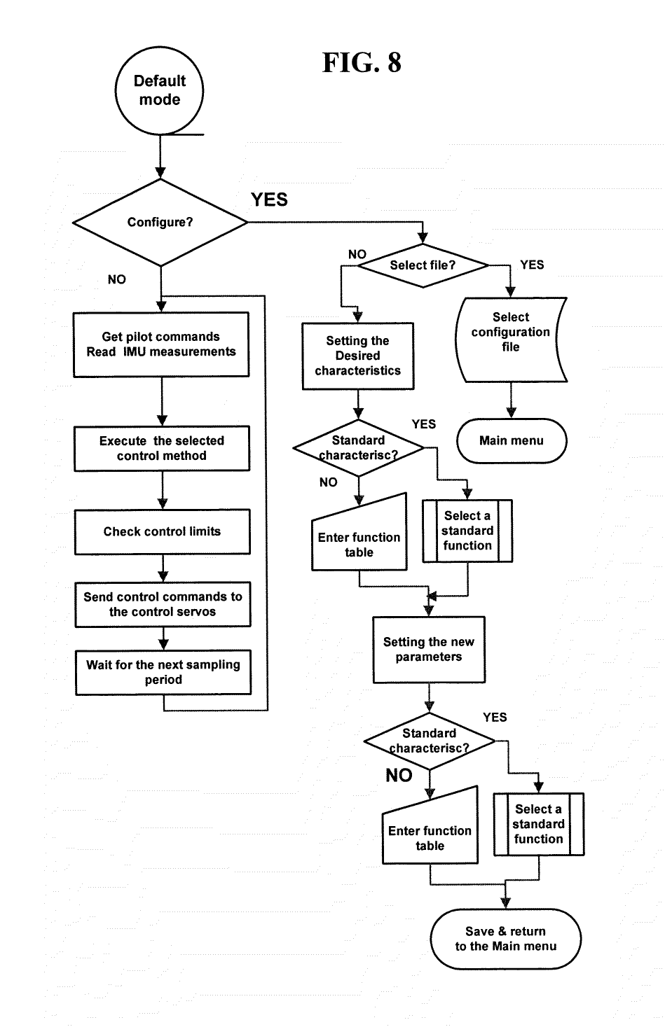

In one embodiment, the center processing core 701 of the flight computer may be a high performance microcontroller with an on-chip serial communion unit. A CPU 702 of the center processing core 701 may fetch instructions sequentially from a program memory 703 and execute them. The program memory 703 may store detailed computational steps as outlined in FIG. 8.

The results of execution may be stored temporarily in one or more banks of general purpose registers 706. The operating system 719 may manage the execution of various tasks, and allocates RAM memories, board resources, and CPU time according to execution priorities of various tasks. The RAM memory 705 may store various measurements, their respective scaled values, and their processed and transformed values. The RAM memory 705 may consist of volatile and non-volatile parts. The non-volatile part of the RAM memory 705 may store the configuration parameters and the setup parameters, the accumulated values, and the identified values. The volatile part of the RAM memory 705 may store the current values, status values, and limited historical values for periodic reporting to a host computer if needed.

Examples of values stored in the non-volatile part of the RAM memory 705 may include: all the measured values, alarms, and pilot commands (required for maintenance, diagnostics, accidents investigation); air vehicle limits (Kₘₐₓ, τₘᵢₙ) for all commands; operational limits (K, τ) during flight (set by an operator or by a mission file); total travelled distance; trip distance; destination location/distance to destination; operating hours of the air vehicle; number of air vehicle trips; total operating hours of the air vehicle; missions files; and/or GIS maps.

Examples of values stored in the volatile part of the RAM memory 705 may include: elevation; forward speed; lateral speed; GIS location; distance from origin/distance to destination; attitude indicator (pitch and roll angles); fuel/battery status; GPS location; outside temperature; RPMs of the four rotors; roll/pitch angle; rate of fuel consumption/total power %; and/or tilt angles of each rotor.

In one embodiment, the execution timing may be determined by a master CPU clock oscillator 708, which may include a special watch-dog timer that produces an alarm and initiates a special reset sequence if the CPU 702 halts for one reason or another. If the board malfunctions, a signal is automatically generated to switch the board to a backup (redundant) board. The timer/counter unit 708 contains a number of programmable digital counters which can be programmed to provide time delays and timing sequences for sampling and for execution of other program fragments. The IMU unit 732 provides the flight measurement vector X at a specified sampling rate. The IMU includes various flight sensors as accelerometers, gyros, GPS, compass, and elevation radar.

In one embodiment, the CPU 702 may internally be connected to a number of digital input/output registers 706 which may interface with external devices via digital I/O channels 709 and 711. The I/O digital channels 711 may be connected to a touch screen 713, which may allow the pilot or operator to initialize operating parameters, configure the software for particular flow characteristics, and for testing and maintenance purpose. The digital I/O channels 711 may interface a control board including the CPU 702 to one or more display unit 714. The display unit 714 may display status parameters, operating mode, values invoked by the operator, error messages, and the measured values.

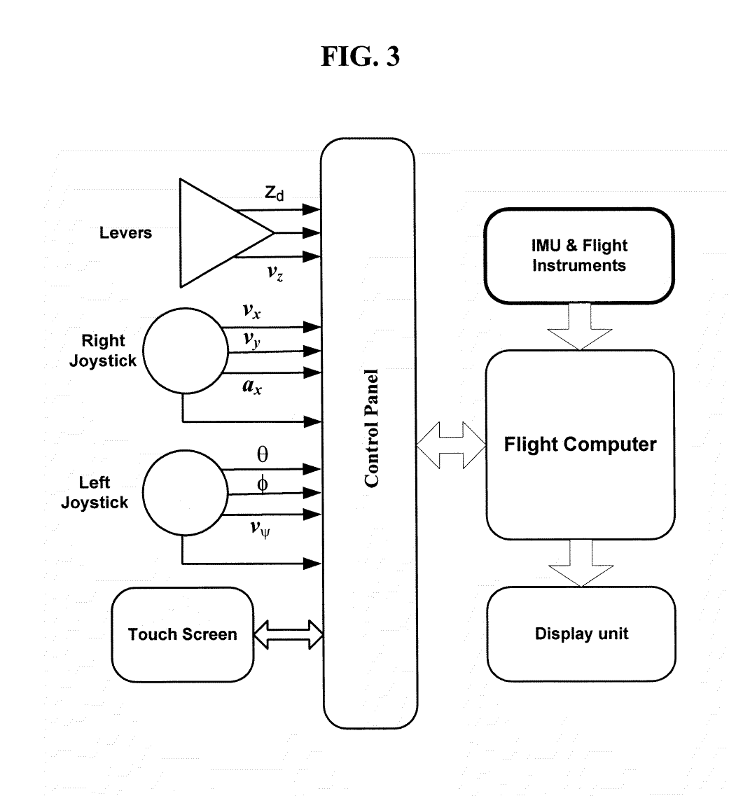

In one embodiment, measured and calculated values may be communicated wirelessly, during an online mode, at a regular rate to a remote host computer via the high speed ports 718, and the high speed communication links 716. The pilot control panel is illustrated in FIG. 3. The control board may comprise a plurality of digital to analog channels 707 which may be used to send control commands to various on board actuators and servo systems, including the four main rotors, and eight servo actuators, which may align the rotors to desired tilt angles. The A/D unit 722 may provide interfaces to various flight sensors, as temperature sensors, batter status, fuel gauges, servos position measurements, hydraulic pressure, etc.

Turning to procedural steps, an exemplary method for controlling a QRAV including up to twelve total control inputs is shown in FIGS. 3 and 8. In one embodiment, execution of all the steps is typically repeated at each sampling period. The sampling rate may be determined by the user depending on the size of the QRAV, and the dynamic response time of the QRAV.

With respect to fault tolerance, the control method for a QRAV with up to twelve total control inputs may be operated using different modes. A QRAV's motion states of interest to pilot control of the aircraft may include: {\dot{x},\ddot{x},\dot{y},ÿ,z,ż,θ,\dot{θ},φ,\dot{φ},\dot{ψ},\ddot{ψ}}, which correspond to: forward speed, forward acceleration, lateral speed, lateral acceleration, elevation, ascending speed, pitch angle, rate of change of pitch angle, roll angle, rate of change of roll angle, yaw angular velocity, and yaw angular acceleration. In one embodiment, the twelve control parameters enable the pilot to have independent control over each of the above QRAV motion states. The twelve control parameters may include:
{ω₁,ω₂,ω₃,ω₄,α₁,β₁,α₂,β₂,α₃,β₃,α₄,β₄}, where {ω₁,ω₂,ω₃,ω₄} are angular speeds of the four rotors, and the rest of the parameters correspond to tilt angles of the four rotors. The QRAV may operate under several modes in case of failure of one or more rotors and/or tilting servo systems.

In one embodiment, a first mode may be a normal mode where there are four fully functional rotors and all twelve control parameters may be available to the pilot:
{ω₁,ω₂,ω₃,ω₄,α₁,β₁,α₂,β₂,α₃,β₃,α₄,β₄}. However, if either the left rotor, or the right rotor, or both the left and right rotors fail, a second mode may be activated where the left and right rotors are shut off All the control commands may then be executed using the front and the rear rotors only. In the second mode, the available control parameters may include {ω₁,ω₃,α₁,β₁,α₃,β₃}, and the pilot would have limited capabilities over six QRAV motion states, which may include {\dot{x},\dot{y},z,θ,φ,\dot{ψ}}. Performance may be reduced as necessary for the conditions in the second mode.

In one embodiment, if the front rotor, the rear rotor, or both the front and rear rotors fail, a third mode may be activated where the front and rear rotors are shut off. All the control commands may then be executed using the left and right rotors only. In the third mode, the available control parameters may include {ω₂,ω₄,α₂,β₂,α₄,β₄}, and the pilot would have limited capabilities over six QRAV motion states, which may include {\dot{x},\dot{y},z,θφ,\dot{ψ}}. Performance may be reduced as necessary for the conditions in the third mode.

In one embodiment, if the servo system for one or two of the four rotors fail, for example if servo motors for one rotor, {α₁,β₁}, fails, a fourth mode may be activated. In the fourth mode, the available control parameters may include
{ω₁,ω₂,ω₃,ω₄,α₂,β₂,α₃,β₃,α₄,β₄}, and the pilot would have limited capabilities over ten QRAV motion states with possible coupling between them. The ten QRAV motion states may include {\dot{x},\dot{y},ÿ,z,ż,θ,φ,\dot{φ},\dot{ψ},\ddot{ψ}}.

In one embodiment, if the servo systems for all of the four rotors fail, a fifth mode may be activated. In the fifth mode, the available control parameters may include {ω₁,ω₂,ω₃,ω₄}, and the pilot would have limited capabilities over only four QRAV motion states with possible coupling between them. The four QRAV motion states may include {\dot{x},z,θ,\dot{ψ}} or {\dot{x},\dot{y},z,\dot{ψ}}.

It is understood that the system and a method for control of quadrotor air vehicles is not limited to the particular embodiments disclosed herein, but embraces much modified forms thereof that are within the scope of the following claims.

1. An air vehicle comprising:
a flight computer;
a fuselage; and
four rotors mounted symmetrically to the fuselage, each of the four rotors including servo mechanism to tilt each of the four rotors about two axes of each respective rotor,
wherein the flight computer is configured to send control parameters to each of the four rotors, the control parameters including a rotational speed, a first tilt angle about a first axis of the two axes of each respective rotor, and a second tilt angle about a second axis of the two axes of each respective rotor.

2. The air vehicle according to claim 1, wherein each of the four rotors are independently tilted about the first axis and the second axis of each respective rotor.

3. The air vehicle according to claim 1, further comprising a control panel,
wherein the control panel receives flight commands,
wherein the flight commands are executed by the flight computer to control the control parameters of the four rotors.

4. The air vehicle according to claim 3, wherein the control panel comprises at least two 3-axis joysticks,
wherein the at least two 3-axis joysticks includes a first joystick and a second joystick,
wherein forward and reverse positions of the first joystick are proportionally linked to forward and reverse speeds of the air vehicle,
wherein left and right positions of the first joystick are proportionally linked to a lateral speed of the air vehicle,
wherein twist of the first joystick is proportionally linked to forward acceleration or forward thrust of the air vehicle.

5. The air vehicle according to claim 4,
wherein forward and reverse positions of the second joystick are proportionally linked to a pitch angle of the air vehicle,
wherein left and right positions of the second joystick are proportionally linked to a roll angle of the air vehicle,
wherein twist of the second joystick is proportionally linked to a yaw angular velocity of the air vehicle.

6. The air vehicle according to claim 5, wherein the control panel further comprises switches to alter and reconfigure the linked functions assigned to the first joystick and the second joystick.

7. The air vehicle according to claim 3, wherein the control panel comprises a first sliding stick and a second sliding stick,
wherein the first sliding stick is linked to an elevation control of the air vehicle, and
wherein the second sliding stick is linked to a speed of ascending and descending of the air vehicle.

8. The air vehicle according to claim 3, wherein the control panel comprises control inputs to set a lateral acceleration, a roll angular speed, a pitch angular speed, and yaw acceleration of the air vehicle.

9. The air vehicle according to claim 3, wherein the control panel receives the flight commands from a location remote from the air vehicle.

10. A method of operating an air vehicle having four rotors, comprising:
receiving flight commands via a control panel of the air vehicle;
translating the flight commands into one or more control parameters for the four rotors,
wherein the one or more control parameters includes a first tilt angle, about a first axis, for each of the four rotors and a second tilt angle, about a second axis, for each of the four rotors.

11. The method of operating the air vehicle according to claim 10, wherein the one or more control parameters includes a rotational speed for each of the four rotors.

12. The method of operating the air vehicle according to claim 10, wherein the flight commands include control of speed and acceleration of forward and lateral motions of the air vehicle without altering a pitch, a yaw, or a roll of the air vehicle.

13. The method of operating the air vehicle according to claim 10, wherein the flight commands include control of elevation and speed of assent or descent without altering a forward or lateral motion of the air vehicle, and without altering a pitch, a yaw, or a roll of the air vehicle.

14. The method of operating the air vehicle according to claim 10, further comprising producing translational motion commands and orientation commands, via a flight computer, based on a programmable flight mission.

15. The method of operating the air vehicle according to claim 10, further comprising:
operating, in a first mode, each of the four rotors when no failures or damage is detected in any of the four rotors;
operating, in a second mode, a front rotor and a rear rotor of the four rotors when a failure or damage is detected in at least a left rotor or a right rotor of the four rotors;
operating, in a third mode, the left rotor and the right rotor of the four rotors when a failure or damage is detected in at least the front rotor or the rear rotor of the four rotors;
operating, in a fourth mode, all four rotors to control angular speeds of each of the four rotors when servo systems for one or two of the four rotors fail, and operating to control tilt angles via servo systems of the four rotors that have not failed; and
operating, in a fifth mode, all four rotors to control angular speeds of the four rotors when the servo systems for all of the four rotors fail.
